(19) United States
(12) Patent Application Publication
(10) Pub. No.: US 2010/0148641 A1
(43) Pub. Date: Jun. 17, 2010

(54) Indoor/Outdoor Kitchen System

(76) Inventor: Robert Ehmke, Menomonee Falls, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/479,123

(22) Filed: Jun. 5, 2009

Related U.S. Application Data
(60) Provisional application No. 61/059,749, filed on Jun. 6, 2008.

(51) Int. Cl. A47B 77/08; A47B 81/00; A47B 83/00; A47B 96/18; H05B 3/68; A47J 37/06

(52) U.S. Cl. 312/100; 312/236; 219/450.1; 99/380

(57) ABSTRACT

The invention described herein is modular system which includes standard components for constructing a code-compliant, customized easily leveled modular kitchen system which can be installed and safely used in non-traditional kitchen settings.

### CROSS-REFERENCE TO RELATED APPLICATIONS

This application claims priority to U.S. Provisional Application No. 61/059,749 filed on Jun. 6, 2008 and U.S. Provisional Application No. 61/059,761 filed on Jun. 7, 2008.

### FIELD OF INVENTION

This invention relates generally to the field of kitchen assembly systems, and in particular to a modular system that can be customized for confined areas in which use of combustible fluids is prohibited.

### BRIEF DESCRIPTION OF THE DRAWINGS

FIG. 1 illustrates an exemplary embodiment of a self-leveling modular kitchen apparatus.

FIG. 2a illustrates an exemplary embodiment of a 90 degree face frame connector.

FIG. 2b illustrates an exemplary embodiment of a face frame connector.

FIG. 3 illustrates an exemplary embodiment of a 45 degree face frame connector.

FIG. 4 illustrates a side sectional view of a counter rail.

FIG. 5 illustrates a top perspective view of an exemplary embodiment of a counter rail.

FIG. 6 illustrates a top perspective view of an exemplary embodiment of a counter rail.

FIG. 7 illustrates a top perspective view of an exemplary embodiment of a horizontal and/or vertical main.

FIG. 8 illustrates a top perspective view of an exemplary embodiment of a horizontal and/or vertical main.

FIG. 9 illustrates a side perspective view of an exemplary embodiment of a horizontal and/or vertical main.

FIG. 10 illustrates a side perspective view of an exemplary embodiment of a horizontal and/or vertical main.

FIG. 11 illustrates an exemplary embodiment of an assemble end panel.

FIG. 12 illustrates an exemplary embodiment of a cabinet frame sub-assembly.

FIG. 13 illustrates an exemplary embodiment of a front or back cabinet frame sub-assembly.

FIG. 14 illustrates an exemplary embodiment of a front or back cabinet frame sub-assembly.

FIG. 15 illustrates an exemplary embodiment a counter rail to a top horizontal face.

FIG. 16 illustrates an exemplary embodiment of a leveling component.

FIG. 17 illustrates an exemplary embodiment of a bottom leveling component.

FIG. 18 illustrates an exemplary embodiment of a vertical main and face frame connector.

FIG. 19 illustrates an exemplary embodiment of an adjustable counter arm.

FIG. 20 illustrates an exemplary embodiment of a configuration of two 135 degree connectors used in conjunction with two straight column connectors.

FIG. 21 illustrates an exemplary embodiment of an adjustable height counter mounting system.

FIG. 22 illustrates an exemplary embodiment of a partial kitchen component.

FIG. 23 illustrates an exemplary embodiment of a partial kitchen component.

FIG. 24 illustrates an exemplary embodiment of a drawer assembly.

FIG. 25 illustrates an exemplary embodiment of a drawer assembly.

FIG. 26 illustrates a side view of an exemplary embodiment of an adjustable counter arm.

FIG. 27 illustrates one embodiment of pivotally mounted electric grill component of a modular kitchen system in the concealed (stored) position.

FIG. 28 illustrates one embodiment of a pivotally mounted electric grill component of a modular kitchen system in an extended position for heating food.

FIG. 29 illustrates a sectional view of a pivotally mounted electric grill component of a modular kitchen system in the concealed (stored) position.

### BACKGROUND

Outdoor kitchens for patios, balconies and decks are often considered a real-estate fixture and a value added enhancement to a home. Outdoor kitchen facilities are also used in industrial, commercial and office settings which are not suitable for traditional kitchen components which would be quickly degraded and damaged by outdoor elements.

Fire codes and insurance regulations generally prohibit the use of combustible and flammable materials and/or the use of outdoor grills in multi-residential settings, and grills often detract from the appearance of an outdoor setting. Grills may also violate rules and ordinances pertaining to the uniform appearance of multi-residential settings.

There are a number of challenges for installing and designing kitchen components for outdoor and non-traditional settings. In particular, leveling such components on uneven surfaces. Sealing of such components is a further challenge, since extensive sealing can detract from aesthetics and ease of use.

Space constraints for configuring outdoor kitchen systems and installing kitchen components in non-traditional settings vary greatly.

It is also a challenge to construct components that can be easily configured, leveled, sealed and installed in an infinite variety of outdoor and non-traditional kitchen settings without insurmountable design costs and training for installation personnel.

In particular, installation of indoor/outdoor kitchens for non-traditional settings and floor-plans (e.g., decks, balconies, sun-rooms, office areas, pool areas, yards, vehicles and outdoor clearings) requires a high level of customization for size, leveling, weather proofing and suitability for physical limitations, dimensions, condominium and community aesthetic codes, fire ordinances, insurance underwriting requirements and outdoor weather conditions. In particular, such systems require considerable experimentation by use and testing to ensure that integrated components are configured effectively within design, physical and climactic constraints unique to the indoor/outdoor custom kitchen industry.

It is desirable to develop a system and method predicated on the use of specialized, standard components and processes which may be taught to and followed by others in order to minimize labor and ensure quality installation.

It is further desirable to have a system which facilitates rapid training of installation personnel, and pursuant to which they can be objectively certified.

Prior art teaches numerous methods for creating and installing customized indoor/outdoor facilities, including elements such as grill systems, storage compartments, refrigerators, work areas and televisions. For example, U.S. patent application Ser. No. 10/438,262 (Thompson '262) teaches a modular outdoor kitchen comprised of a number of weather resistant modules. The modules are releasably connected together, allowing assembly and configuration. This publication further teaches the use of a number of the outer faces include panels to provide a weather resistant outer surface. However, reliance on a limited number of pre-configured modules and panels limits the use of this invention when specially dimensioned and highly customized indoor/systems are required. Additionally, the water resistant aspects of the system taught are not calculated to provide a product having maximum durability.

U.S. patent application Ser. No. 11/339,013 (Kenny '013) discloses a method and system for constructing a grill island or support structure. This structure includes modular units, which may be configured to hold the grill, enclose a refrigerator, store a trash bin or storage drawers, or be adapted for other purposes. Each modular unit includes a frame made up of interconnecting elements defining an open interior and a covering extending over the frame, generally to create a face and a top. A number of these modular units are connected together to form a unitary structure, such as a grill island. This invention also requires reliance on a limited number of pre-configured modules and panels and is directed primarily to a frame or kit for making a frame for stabilizing such units. This invention would not be suitable for a specially dimensioned and highly customized indoor/system for use on a structure such as a deck, without considerable expense for modifying the deck structure, and considerable installation labor to modify the frame. This invention is limited to providing a frame for outdoor kitchens which requires minimal different types of parts and allows simplified creation of level surfaces for attaching faces and tops. However, this system does not allow customization of components and does not address issues such as long-term durability and complex customization requirements that require costly labor and skilled assembly by trained professionals. While a “kit” results in increased assembly efficiency, the resultant product is not customized because there is a continued reliance on modular units. This method and system also does not address quality control standards since it is designed for installation for un-trained personnel and homeowners, without the benefit of precisely measured, cut and machined parts for accuracy and weather resistance.

Other relevant prior art include U.S. patent application Ser. No. 11/382,211, (Kenny et al. '211) and U.S. Pat. No. 6,877,825 (Khosropour '825). Kenny '211 teaches frame structure to which modular units “of standard sized and height” are mounted. The invention taught in the '585 patent is sold as a “kit or for self-assembly.” It does teach the use of rails and corner braces, but the components taught are limited to use for a frame into which modular units can be inserted.

Khosropour '825 teaches a modular kitchen system which enables a customer to adjust the vertical height for appliances and storage units. This system is not designed, however, for outdoor use or to be installed in non-traditional areas such as a sunroom or basement.

Modular units require inventory of uniform size units. Customized, high-quality installations require trained personnel skilled in the assembly of accurately machined and cut parts designed to provide weather resistance, proper leveling and appropriate design configuration for a non-traditional setting and floor plan. Reliance on an inventory of modular units limits the possible configurations of indoor/outdoor kitchens based on the modular components in inventor, and thus the ability to install a full custom size indoor/outdoor kitchen in a non-traditional setting such as a deck, porch, or other recreational area without considerable on-site labor and expertise. Moreover, customization using traditional modular systems and frames fails to ensure consistent quality and skill levels by using consisting parts, standards and testing methods specially developed for the installation of long-term, durable, high-quality kitchens.

It is thus desirable to have a standardized system for creating precise custom parts, designed for specific indoor/outdoor use which utilizes a tested, quality assured, standard installation method which can be taught to others and systematically monitored and reviewed.

It is further desirable to have a highly efficient system for installing customized indoor/outdoor kitchen systems that maximizes the number of available configurations.

It further desirable to have a system which can be easily leveled an adjusted on outdoor surfaces which may be un-even or may shift over time.

It is further desirable to have a method and system for installing customized indoor/outdoor kitchen systems that can be taught to others so that the quality of installations and level of efficiency is consistent regardless of the personnel performing the installation and level of customization required.

It is further desirable to have an indoor/outdoor system which utilizes component parts that can be economically produced, have high levels of consistency, durability and weather resistance and which can be varied based on aesthetic preferences of a customer.

It is further desirable to have a method and system for installing customized indoor/outdoor kitchen systems that can be taught to others so that the quality of installations and level of efficiency is consistent regardless of the personnel performing the installation and level of customization required.

### SUMMARY OF THE-INVENTION

The invention described herein is a standardized system for creating precise custom parts, designed for specific indoor/outdoor use which utilizes a tested, quality assured, standard installation method which can be taught to others and systematically monitored and reviewed. The invention provides an integrated system of specially designed and treated parts which may be custom machined and tooled in various steps and aspects of the system. The resultant invention is a highly efficient system for installing customized indoor/outdoor kitchen systems that maximizes the number of available configurations, minimizes labor costs and labor error, minimizes the need for on-sight labor and provides maximum durability and maximized the number of effective custom configurations that can be created in non-traditional kitchen settings.

A self-leveling modular kitchen system adapted for code-compliant use in multi-residential housing. Various embodiments may include one or more self-leveling components comprised of cams any other functionally equivalent mechanical apparatus.

Further embodiments may include code-compliant electrical grilling components, concealed grilling components which may or may not be pivotally mounted or spring loaded, vertical and horizontal mains having a variety of notches and structural configurations.

Various embodiments may also include infinite configurations of panels, counter rails, adjustable arms, tracks and frame connectors, as well as structural configurations to facilitate attachment of weather stripping material. These configurations for attaching and minimizing the appearance of weather stripping may include, but are not limited to grooves, notches, apertures and protuberances.

The self-leveling modular kitchen system may include various self-leveling components and spring loaded components, including one or more grilling surfaces capable of being stored within a cabinet structure (e.g., pivotally mounted and extended to provide sufficient clearance from the walls of the cabinet structure to permit cooking using said at least one electric grilling surface).

### GLOSSARY

As used herein, the term “outdoor” or “non-traditional kitchen setting” means any setting which is not contemplated in the original construction of a home, including but not limited to yards, patios, decks, pools, pavilions, balconies, motor vehicles, boats or any other building or structure capable of containing a mobile kitchen.

As used herein, the term “kitchen” means an area comprised of one or more proximate food preparation storage areas, appliances and surfaces collectively and individually referred to as kitchen components.

As used herein, the term “customized” or “customized kitchen” refers to a kitchen component which is manufactured according to dimensions and specifications determined by a customer, vendor, designer or other party, rather than selected from components having specifications identified by the manufacturer.

As used herein, the term “vertical main” or “horizontal main” means a support structure for panels, drawers, countertops, appliances, fixtures, rails and other components or parts used to create a customized kitchen. For example a vertical main or horizontal main may be a custom cut or stock length extruded metal (e.g., aluminum or steel component) having a width within a range of one to four inches. A vertical main or horizontal main may include any configuration of notches, grooves and apertures to facilitate assembly of custom kitchen components. A vertical or horizontal main may further include a special groove for weather stripping material, and have weather stripping material affixed.

As used herein, the term “weather stripping material” includes any foam, fabric, caulk, felt, vinyl, synthetic or other material designed to enhance moisture and weather resistant qualities of a structure by minimizing cracks or spaces or by providing additional protection or insulation.

As used herein, the term “notch” means a cut, machined, or tooled configuration to facilitate assembly of multiple components. For example, a vertical or horizontal main may include notches to allow them to be fitted together.

As used herein, the term “horizontal face,” “top horizontal face” or bottom horizontal face” means a component attached to a vertical or horizontal main which provides a structure into which kitchen components may be fitted. In various embodiments described herein, a horizontal face may be constructed of aluminum or steel and coated with a weather resistant coating and/or other surface coatings and configurations which increase weather resistance and durability, and provide support for customized components.

As used herein, the term “panel” means a component constructed of lightweight aluminum, steel, plastic or other material which is used to construct doors, cabinets, storage areas, shelves and other customized kitchen components. A panel may be constructed by cutting or machining aluminum, including but not limited to such processes as cutting, measuring, shearing, notching and forming. A panel may also be extruded metal, and may or may not include a groove or configuration for adding weather stripping material.

As used herein, the term “counter rail” means a specially, designed component to create a functional and/or aesthetic transition or connection between a horizontal face (generally a top horizontal face) and a counter-top or other surface.

As used herein, the term “face frame connector” means a component used to connect panels or other components to create a cabinet, storage area or other housing having a customized depth and/or other customized dimensions.

As used herein, the term “adjustable height counter mounting system” means a system of one or more height adjustable components to support a counter top and make the counter top conform to the necessary elevation to conform to the edge of a counter rail. For example, a counter mounting system may include mounting components which can be raised or lowered to adjust for the thickness of varying types of countertops such as tile, granite and porcelain. Such thicknesses may range from ¼ of an inch to 1.5 inches in thickness.

As used herein, the term “adjustable counter arm” is a component which is attached to a vertical main, and which allows countertops and other surfaces to be installed and configured at varying heights (e.g., bar height). The adjustable arm component can be raised or lowered to level components after settling, or to provide any other height adjustment which may be necessary or desirable for installing and configuring custom kitchen components.

As used herein, the term “self-leveling system” or “self-leveling component” means, a spring loaded component which automatically adjusts the size and appearance of a bottom horizontal face as cabinets are raised or lowered, and which is secured with screws to extend and conform the dimension of a bottom horizontal face to the door, cabinet or other customized component being installed.

As used herein, the term “confined outdoor space” means a balcony, elevated deck, roof deck or any other small outdoor space. Confined outdoor space shall also be defined as equivalent to an indoor space, such as a small kitchen, office, or any other indoor or outdoor facility which was not originally designed or configured for a kitchen and did not include a kitchen when originally constructed.

As used herein, the term “code-compliant” means a modular, electrical kitchen or grilling component which does not rely on flammable fluids, charcoal, wood or an open flame to provide heat for cooking, and thus increases the likelihood that such heating elements will meet housing, fire and insurance code standards.

As used herein, the term “multi-residential housing” means an apartment, duplex, townhome, condominium or home within a neighborhood.

As used herein, the term “cam component” means a projecting part of a rotating wheel or shaft that strikes a lever at one or more points on its circular path, or any apparatus which serves the functional equivalent of a cam component.

### DETAILED DESCRIPTION OF EMBODIMENTS OF THE INVENTION

For the purpose of promoting an understanding of the present invention, references are made in the text hereof to embodiments of an indoor/outdoor kitchen installation system, only some of which are depicted in the figures. It should nevertheless be understood that no limitations on the scope of the invention are thereby intended. One of ordinary skill in the all will readily appreciate that modifications such as the dimensions, size, and shape of the components, alternate but functionally similar materials from which elements of the indoor/outdoor kitchen installation system are made, and the inclusion of additional elements (in particular additional system parts or modifications to system parts that perform an equivalent function) are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related. All elements of the indoor/outdoor kitchen installation system described herein may be configured in limitless shapes and sizes.

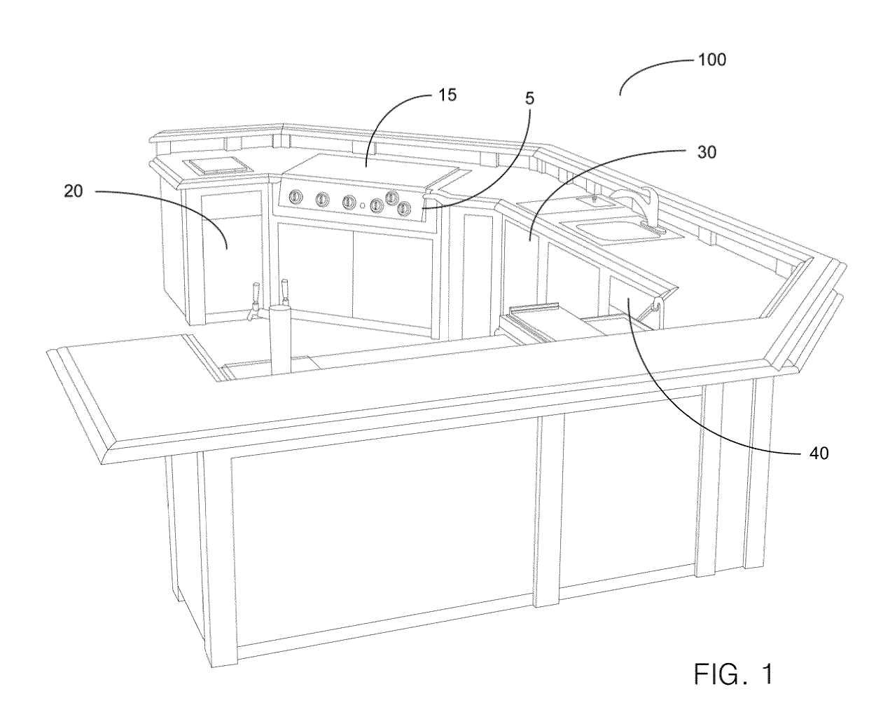

Referring now to the drawings, FIG. 1 illustrates one embodiment of a self-leveling modular kitchen system 100 with pivotally mounted electric grill component 5 shown in the concealed position giving modular kitchen system 100 a streamline aesthetic appearance when not in use. In the embodiment shown, pivotally mounted electric grill component 5 has grilling surface 15.

The embodiment of self-leveling modular kitchen system 100 shown in FIG. 1 further includes and self-leveling cabinets 20, 30, and 40.

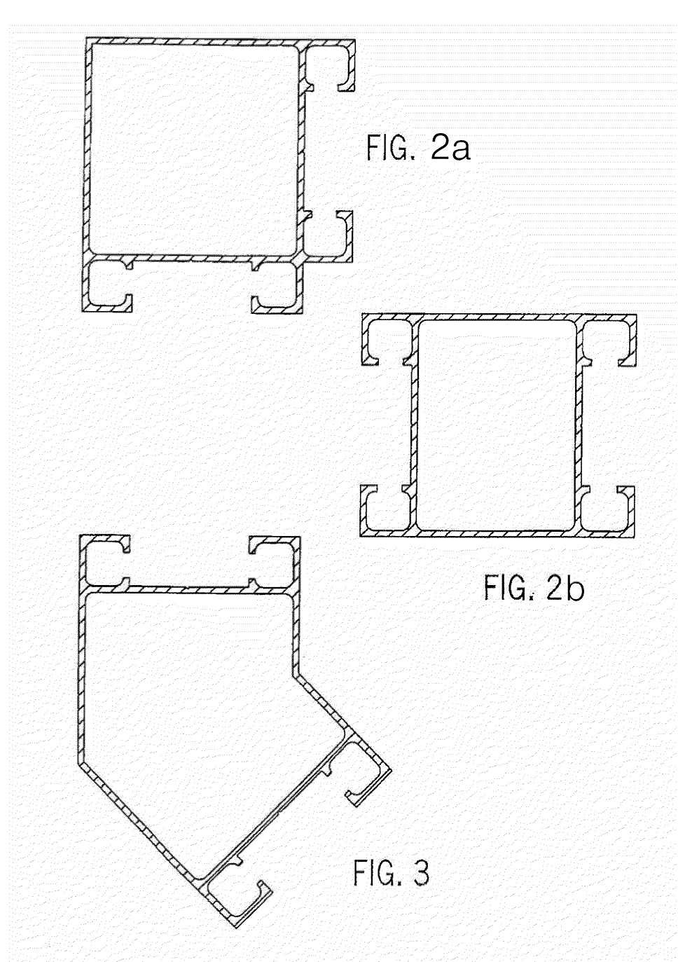

FIGS. 2a, 2b, and 3 are top perspective views of three exemplary embodiments of a face frame connector.

FIG. 2a shows an exemplary embodiment of a 90 degree face frame connector which creates a right-angle transition to the “running face” or a panel used to construct a custom indoor/outdoor kitchen component.

FIG. 2b illustrates a second exemplary embodiment of a face frame connector, referred to as a “straight face frame column connector” which is used to connect custom/indoor outdoor components in a straight line configuration.

FIG. 3 illustrates a further embodiment of a 45 degree face frame connector outside transition to the running face self-leveling modular kitchen system 100.

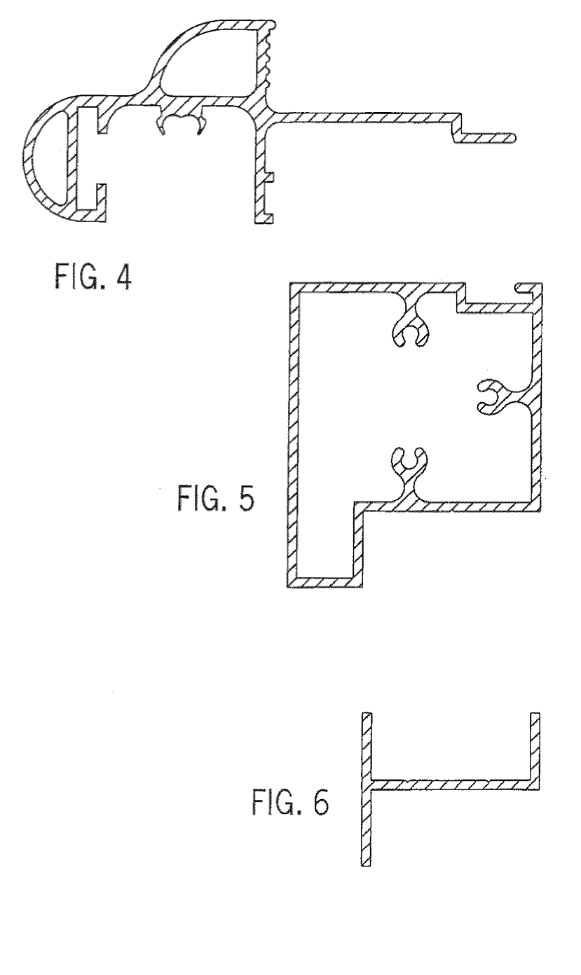

FIG. 4 illustrates a side sectional view of a counter rail which creates a transition or connection between a horizontal face (generally a top horizontal face) and a counter-top or other surface.

FIG. 5 and FIG. 6 illustrate a top view of various possible embodiments of a counter rail, which may include tabs to connect onto the adjoining counter rails. In some embodiments, stainless steel set screws secure tabs to the counter rails thus preventing the assembled counter rails from being raised out of the slot in the vertical main and/or horizontal main.

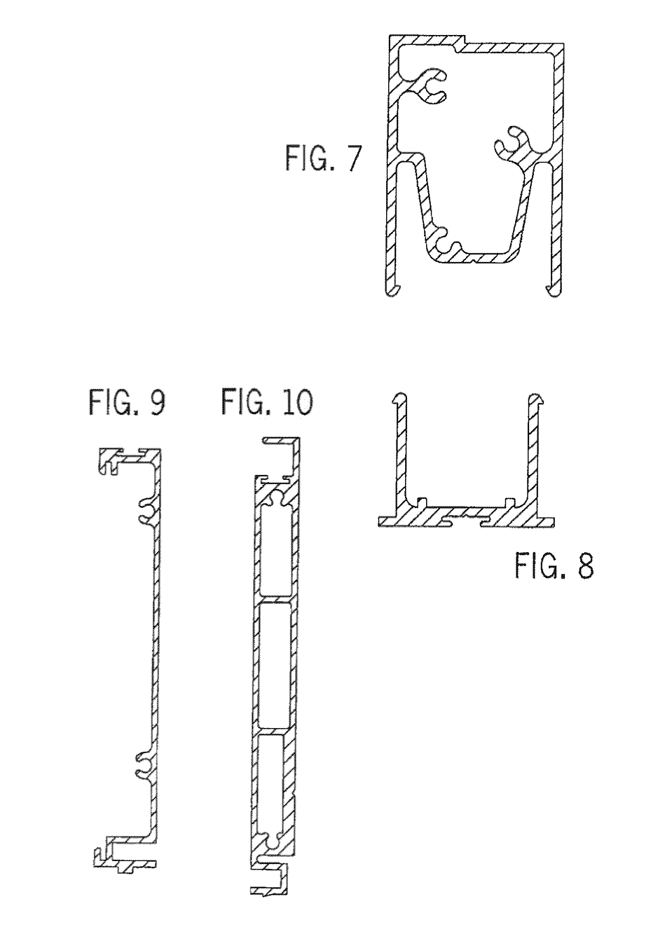

FIGS. 7 and 8 illustrate a tope perspective view of exemplary embodiments of a horizontal and/or vertical main. In various embodiments shown, the main may be used to form a cabinet assembly frame which may include notches, apertures and other features for connecting multiple horizontal and vertical mains.

FIGS. 9 and 10 illustrate side perspective view of exemplary embodiments of a horizontal and/or vertical main. In various embodiments shown, the main may be used to form a cabinet assembly frame which may be included notches, apertures and other features for connecting multiple horizontal and vertical mains.

In various embodiments of the invention described herein, mains serve as a support structure for panels, drawers, countertops, appliances, fixtures, rails, other mains, adjustable arm components and various components used to create a customized kitchen. A vertical and/or horizontal main may be a custom cut or stock length extruded metal (e.g., aluminum or steel component) having a width within a range of one to four inches. A vertical and/or horizontal main may include any configuration of notches, grooves and apertures to facilitate assembly of custom kitchen components. A vertical and/or horizontal main may further include a special groove for weather stripping material, and have weather stripping material affixed.

In various embodiments, vertical and/or horizontal mains may be used to construct drawer assemblies which are then secured to the mains via socket-head screws in each corner. Screws may be recessed through in the outer face of the vertical and/or horizontal mains. Prior to tightening screws, the drawer bottom aluminum sandwich panel is inserted into slots at the bottom of front, back and side sections, Access holes (apertures) may capped after screws are in place with snap-in covers (cap) resulting in an aesthetically pleasing look to the drawer side when open.

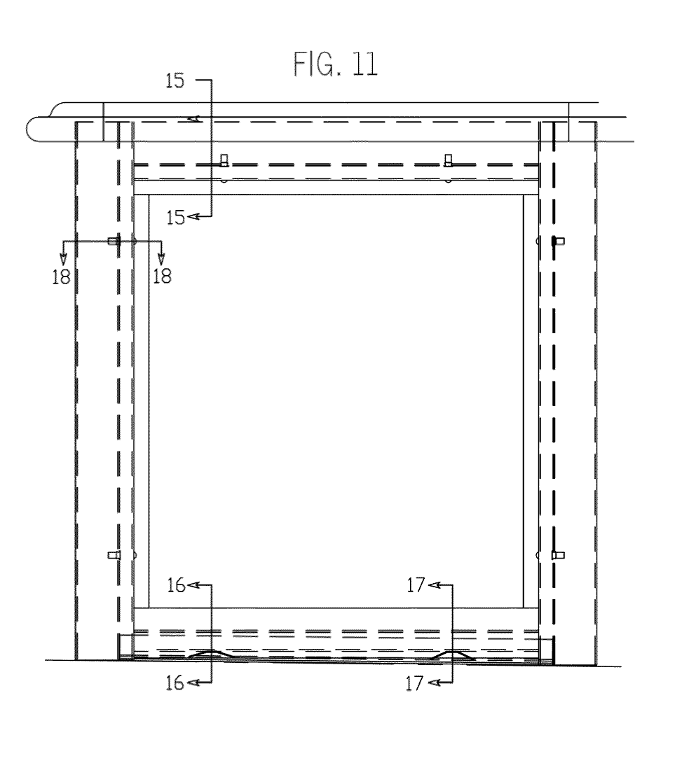

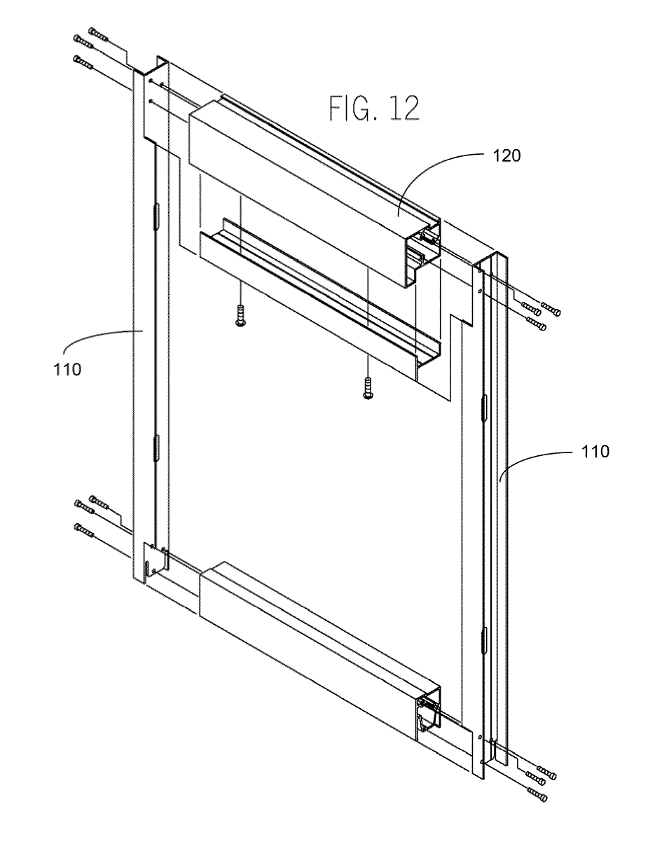

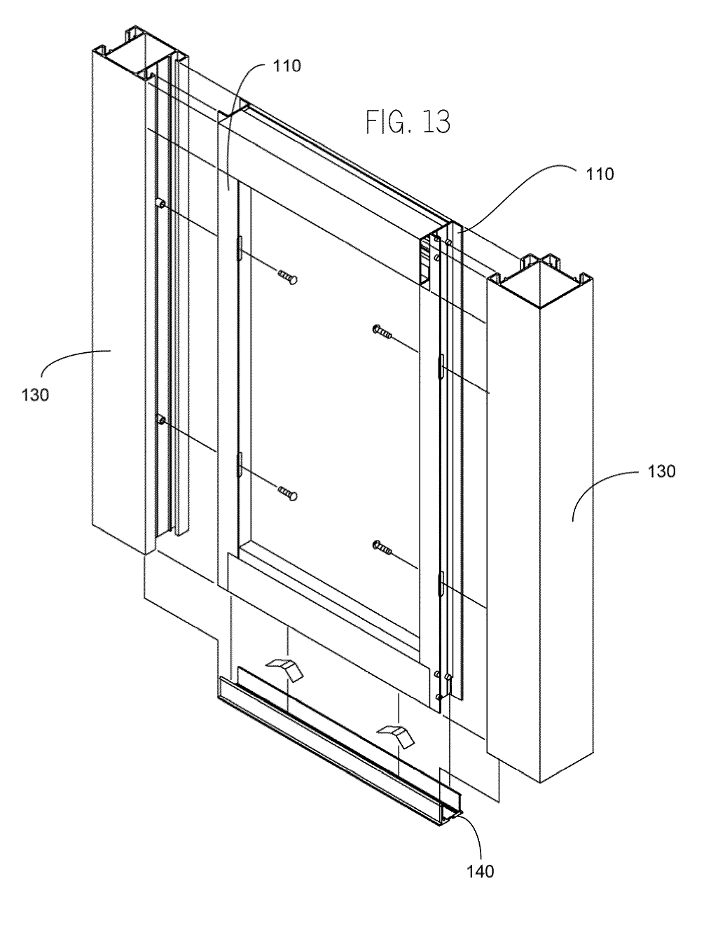

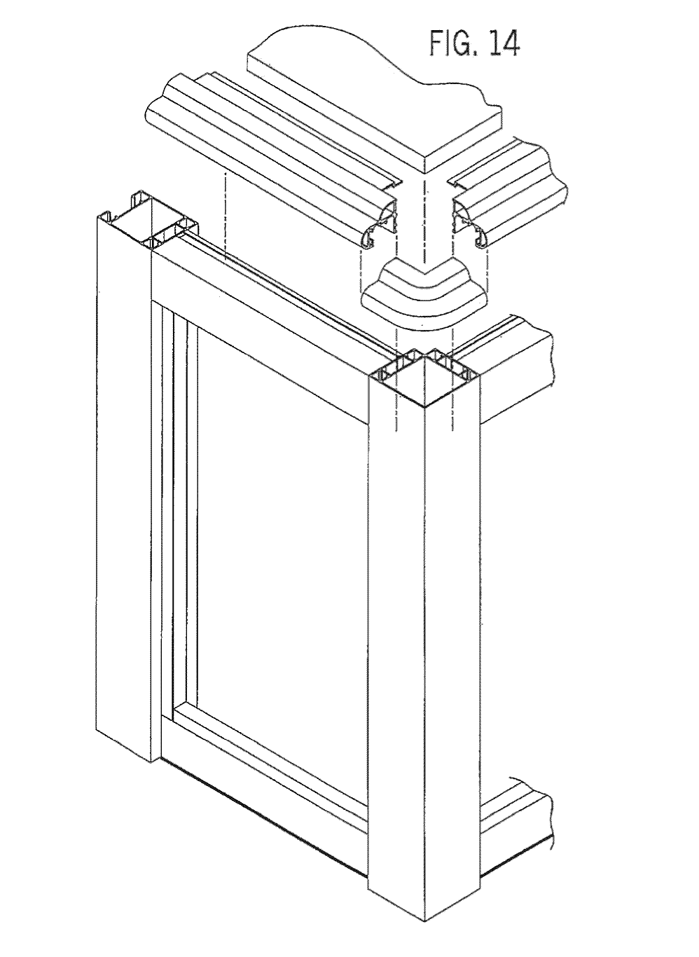

FIG. 11 illustrates and exemplary embodiment of an assembled end panel for a customized kitchen component. The embodiment shown and various customized kitchen components similarly constructed may further include a decorative panel and/or may be coated with a weather resistant coating and/or other surface coatings and configurations which increase weather resistance and durability, and provide support for customized components. Examples of commercially available weather resistant coatings which may be used include coatings available though Spraylat of Gainesville Tex., including Decaflon™. Weatherproof coatings in various embodiments of the invention described herein will be tested for dry film hardness, film adhesion, impact resistance, abrasion resistance, chemical resistance, weather resistance, corrosion resistance and other qualities for a coating suitable for application to lightweight aluminum and other metals and plastics which may be used to construct customized kitchen components.

FIG. 12 illustrates an exemplary kitchen cabinet frame sub-assembly which is comprised of vertical and/or horizontal mains 110. In the embodiment shown, the vertical and horizontal mains are notched on both ends and “nest” into each other to create the frame sub-assembly. Vertical mains are secured to top and bottom counter rails 120 and are secured with screws which pass through corresponding apertures.

FIG. 13 illustrates a further exemplary embodiment of a front or back cabinet frame sub-assembly. Visible in FIG. 13 are horizontal and vertical mains 110, vertical column connectors 130 and a bottom leveling component 140.

FIG. 14 illustrates a further exemplary embodiment of a front or back cabinet frame sub-assembly. Visible in FIG. 14 is a counter rail 150 which accommodates commercially available countertop materials of varying thicknesses. In some embodiments, spacers of varying thicknesses may be applied beneath the top to bring it flush with the top of the counter rail.

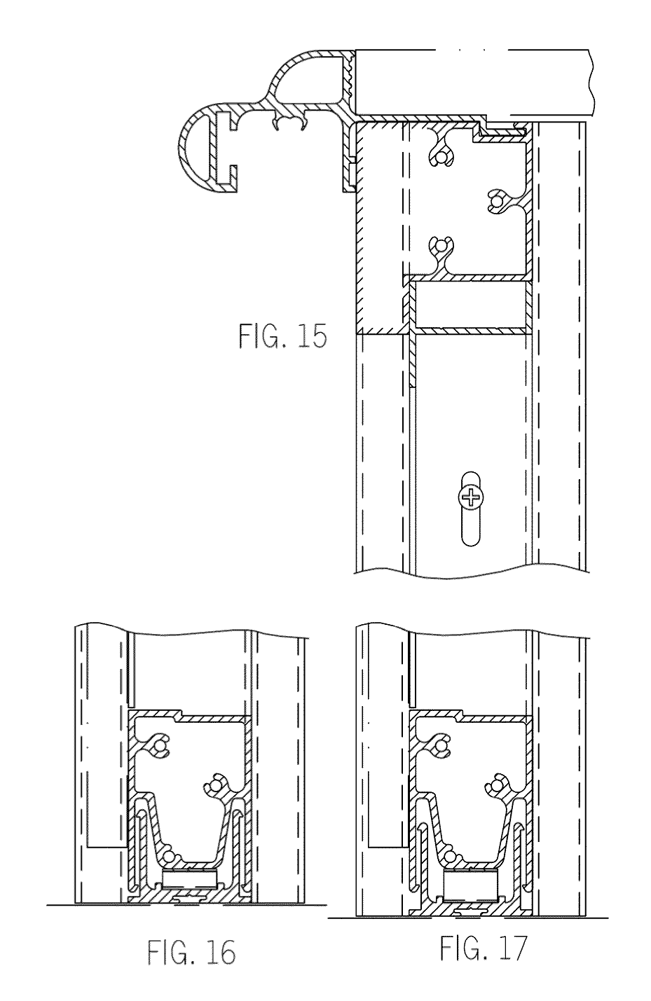

FIG. 15 illustrates a counter rail to a lop horizontal face, creating a base on which a countertop can be mounted.

FIG. 16 illustrates the relationship of a leveling component with a spring loaded configuration to allow it to adjust and create a seamless aesthetic appearance with the bottom horizontal face component.

FIG. 17 illustrates a further embodiment of a bottom leveling component connected to a bottom horizontal face, with the spring assembly compressed. The bottom leveling component further ensures a seal between the bottoms of the front/back frame assembly, and is further capable of supporting a decorative panel applied for aesthetic purposes (e.g., a brick or stone front).

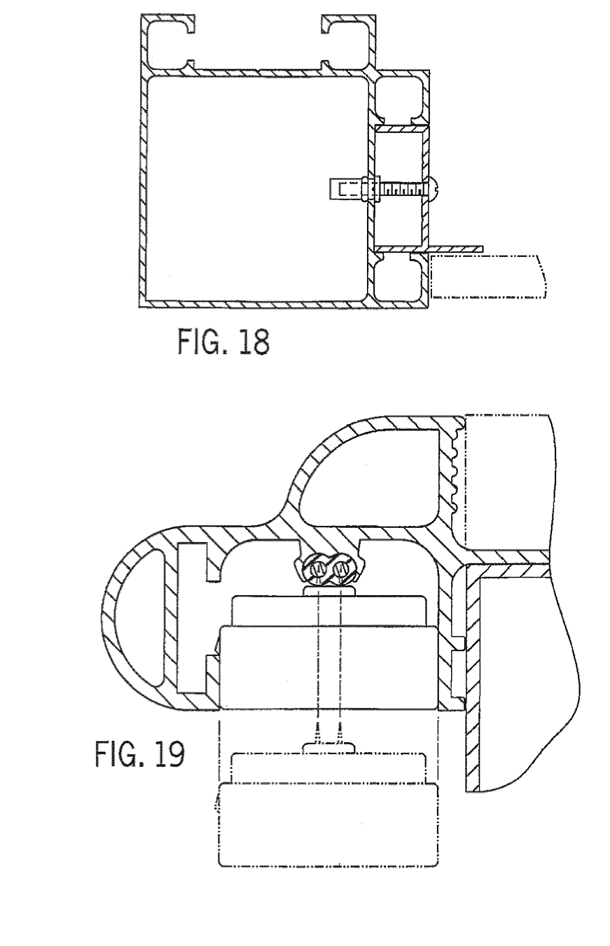

FIG. 18 illustrates the relationship of a vertical main to a face frame connector. In the embodiment shown, stainless steel machine screws which pass through slots in the mains and secure the column connectors.

FIG. 19 illustrates an exemplary adjustable counter arm. In the embodiment shown, the adjustable counter arm raises the counter rail to accommodate an optional rail lighting component (comprising a light, permeable panel and lighting system). The adjustable counter arm is a unique cabinetry component which is attached to a vertical main, and which allows countertops and other surfaces to be installed and configured at varying heights (e.g., bar height) to fully customize a kitchen system. The adjustable arm component can be raised or lowered to level components after settling, or to provide any other height adjustment which may be necessary or desirable for installing and configuring custom kitchen components.

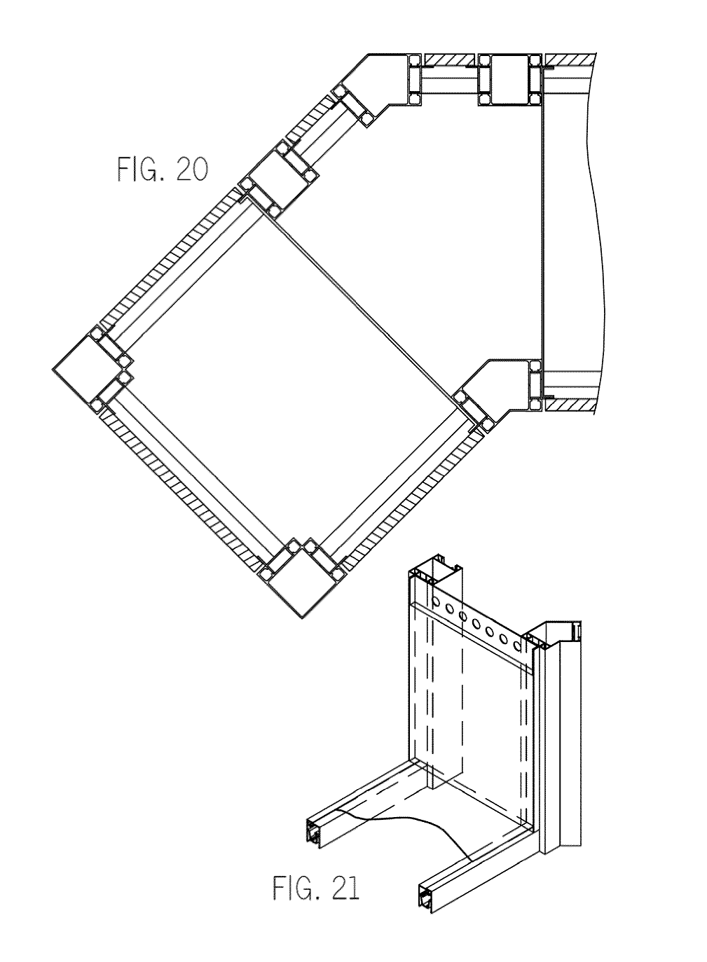

FIG. 20 illustrates a configuration of 135 degree column connectors are in conjunction with the two straight column connectors to create the 45 degree transition.

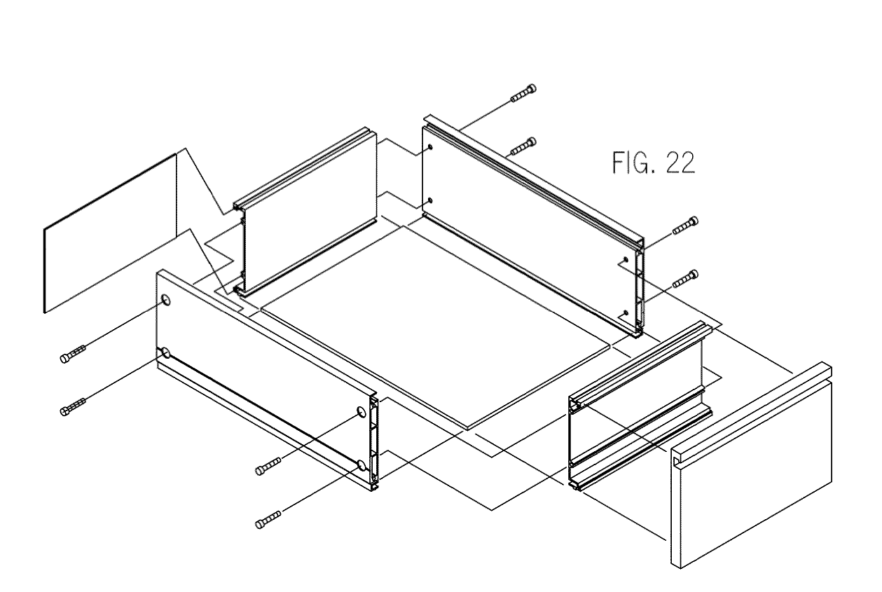

FIGS. 20 and 21 further illustrate an adjustable height counter mounting system. In the embodiment shown, several supporting members are connected to adjustable elevator bolts which allow for counter top leveling and height adjustment to accommodate various thicknesses of commercially available countertops (e.g., ceramic, granite, concrete, stone, wood, stainless steel, etc.). Also visible in FIG. 21 are utility channel holes for passage of gas lines and electric wiring.

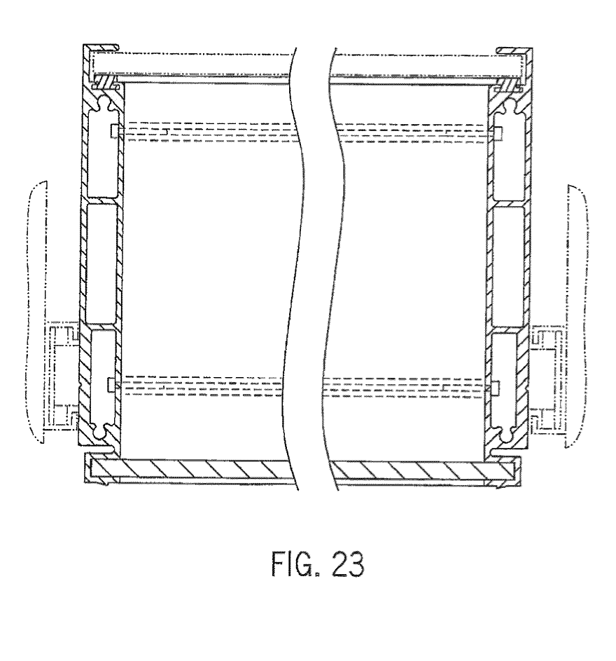

FIGS. 22 and 23 illustrate a partial exemplary embodiment of a custom kitchen component in which drawer panels are constructed from lightweight aluminum, plastic or stainless steel components. The embodiment shown includes a groove in the side that traverses the length of the section and passes through the lower screw access holes. Weather stripping material may be to the top edges of the front, back and side sections, and the assembly shown in FIG. 23 may further include a polycarbonate drawer cover to protect the contents of the drawer from moisture, bugs, etc.

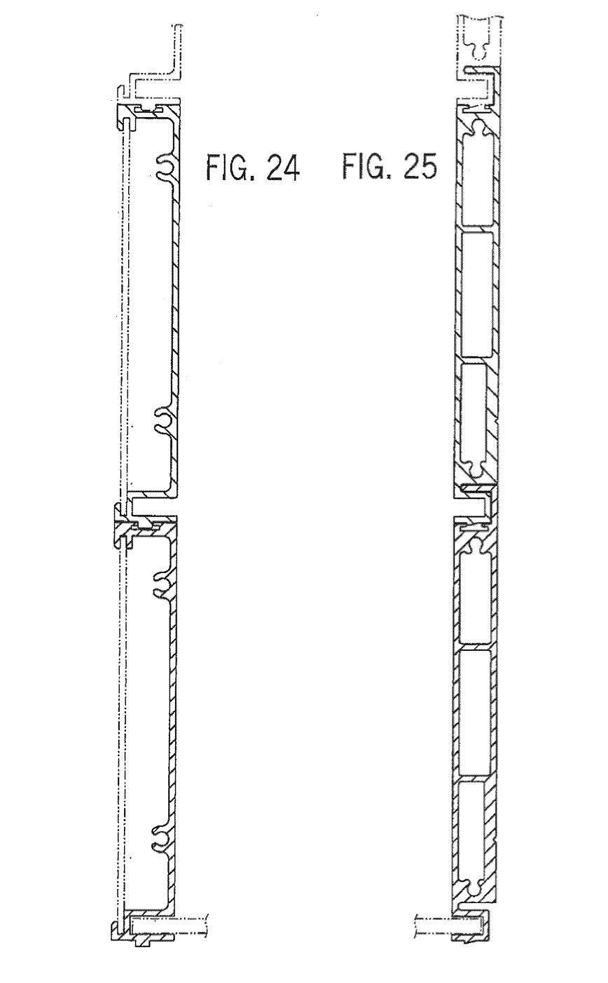

FIGS. 24 and 25 illustrate an embodiment of the invention in which the drawer assemblies are assembled in a multiple, drawer vertical configuration. In the embodiment shown, the interlocking of drawer side, front and rear sections, tops to bottoms, when combined with socket-head screw tightening, create a solid assembly with the illusion of being one piece. Front, back and side sections can be stacked in 2 sections to 4 sections allowing for varying drawer depths.

Also visible in FIGS. 24 and 25 are a side panel and a floor panel. These panels are constructed of aluminum, stainless steel or powder-coated aluminized steel.

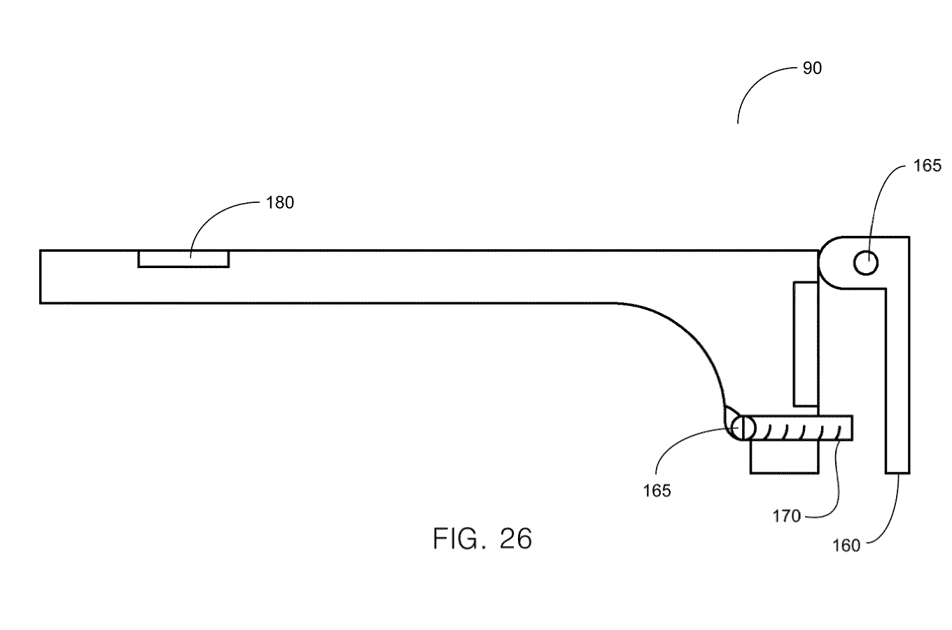

FIG. 26 illustrates a side view of one embodiment of adjustable counter arm 90. In the embodiment shown, adjustable counter arm 90 raises the counter rail to accommodate an optional rail lighting component (comprising a light permeable panel and lighting system). The adjustable counter arm is a unique cabinetry component which is attached to a vertical main, and which allows countertops and other surfaces to be installed and configured at varying heights (e.g., bar height) to fully customize a kitchen system. Adjustable counter arm 90 can be raised or lowered to level components after settling, or to provide any other height adjustment which may be necessary or desirable for installing and configuring custom kitchen components.

In the embodiment shown, adjustable counter arm 90 has a mounting surface 160 which is connected to a vertical support structure or frame used for cabinetry. Mounting surface 160 includes at least one aperture 165 through which screws, bolts or functionally equivalent components 170 are used to attach adjustable counter arm 90 to a cabinetry frame or support structure at variable height levels.

FIG. 26 further illustrates supporting arm 180 which is used to support a counter, work surface panel or other structure. Supporting arm 180 may be adjustable, fixedly attached or a separately or singly molded component.

In other embodiments, supporting arm 180 may include a notch or one or more machined configurations to secure or support a kitchen component.

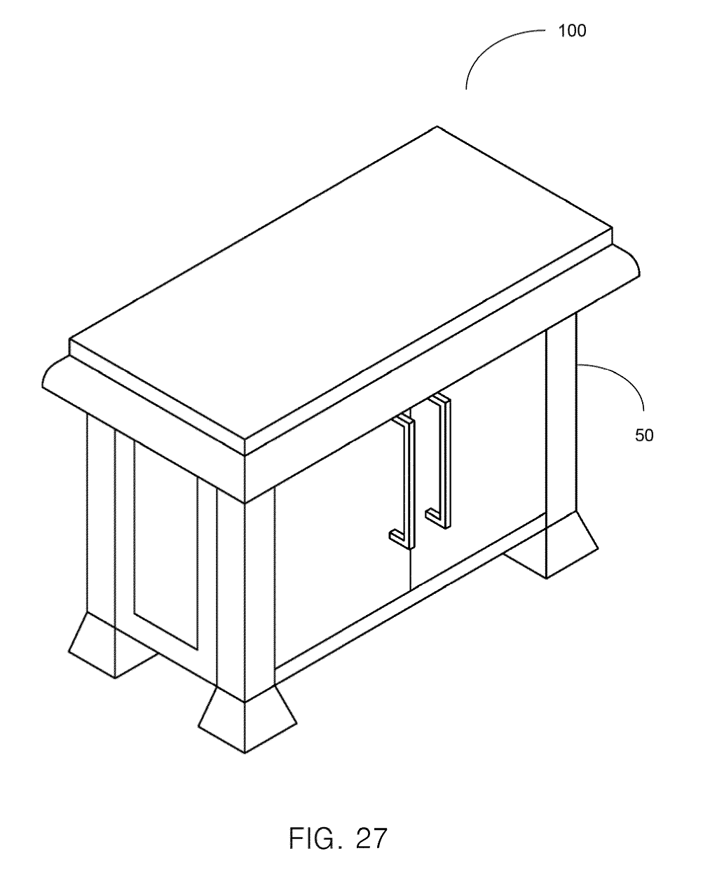

FIG. 27 illustrates one embodiment of a pivotally mounted electric grill component 10 of a modular kitchen system 100 in the concealed (stored) position, having grilling surface 15 (not shown). Pivotally mounted electric grill 10 is concealed inside cabinet structure 50, which is closed. Also concealed inside cabinet structure 50 is pivotally mounted shelf 60 (not shown) which is capable of being pivoted and extended to provide sufficient clearance away from the interior of cabinet structure 50 while using grilling surface 15 for cooking.

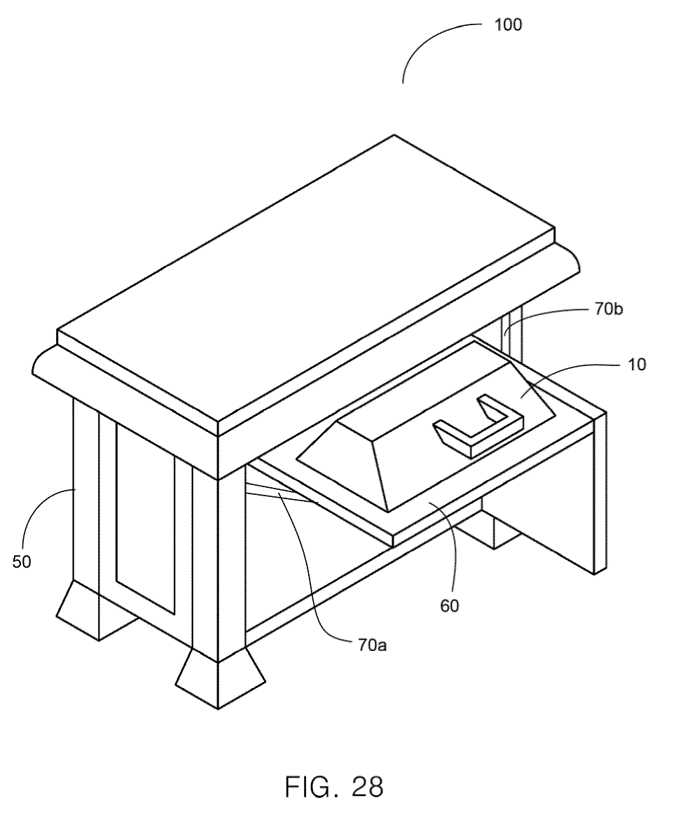

FIG. 28 illustrates one embodiment of pivotally mounted electric grill component 10 of a modular kitchen system 100 in an extended position for heating food. Cabinet structure 50 contains pivotally mounted shelf 60 and pivot arms 70a and 70b. In the embodiment shown, pivotally mounted shelf 60 is in the extended position. In other embodiments, pivot arms 70a and 70b are spring-loaded.

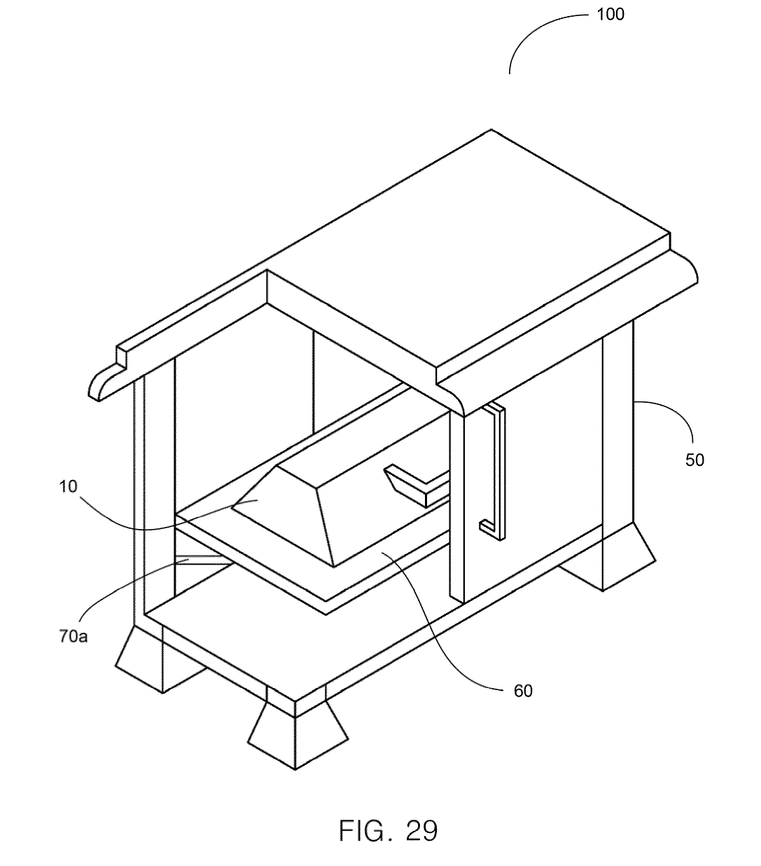

FIG. 29 illustrates a section view of one embodiment of pivotally mounted electric grill component 10 of a modular kitchen system 100 in the concealed (stored) position.

Additional embodiments of method and system described herein may include and/or utilize varying configurations of the following elements without changing the functionality of modular kitchen system 100 and the various components described herein: 90 degree connectors, 135 degree connectors; 190 degree connectors; bottom and top horizontals; bottom levelers; counter rails; side drawer rails; front back drawer rails; filers; receivers; top channels; appliance liners; appliance top horizontals; mains; mullions and cross braces.

What is claimed is:

1. A code-compliant, outdoor, modular, electrical kitchen system comprised of:
at least one electrical power source;
at least one electrical grilling component;
at least one vertical main;
at least one horizontal main;
at least one horizontal face;
at least one panel;
at least one counter rail; and
at least one face frame connector.

2. The kitchen system of claim 1 wherein said at least one vertical main further includes a notch capable of securing a modular outdoor kitchen component selected from a group consisting of panels, drawers, countertops, appliances, fixtures, and rails.

3. The modular kitchen system of claim 1 wherein said at least one horizontal main further includes a notch capable of securing a modular outdoor kitchen component selected from a group consisting of panels, drawers, countertops, appliances, fixtures, and rails.

4. The modular kitchen system of claim 1 which further includes at least one adjustable counter arm adapted to allow countertops and other surfaces to be installed and configured at varying heights.

5. The modular kitchen system of claim 1 which further includes a self-leveling component.

6. The modular kitchen system of claim 1 which further includes at least one code-compliant electrical grilling component.

7. The self-leveling modular kitchen system of claim 1 wherein said horizontal main includes structural configurations to facilitate attachment and minimize the appearance of weather stripping material, said structural configurations being selected from a group consisting grooves, notches, apertures and protuberances.

8. A self-leveling modular kitchen system adapted for code-compliant use in multi-residential housing, said system comprised of:
at least one self-leveling component;
at least one code-compliant electrical grilling component;
at least one vertical main having at least one notch capable of securing a modular outdoor kitchen component selected from a group consisting of panels, drawers, countertops, appliances, fixtures, and rails;
at least one horizontal main having at least one notch capable of securing a modular outdoor kitchen component selected from a group consisting of panels, drawers, countertops, appliances, fixtures, and rails;
at least one horizontal face;
at least one panel;
at least one counter rail; and
at least one face frame connector.

9. The self-leveling modular kitchen system of claim 8 which further includes at least one adjustable counter arm adapted to allow countertops and other surfaces to be installed and configured at varying heights.

10. The self-leveling modular kitchen system of claim 9 which further includes at least one cam component.

11. The self-leveling modular kitchen system of claim 8 wherein said horizontal main includes structural configurations to facilitate attachment of weather stripping material, said structural configurations being selected from a group consisting of grooves, notches, apertures and protuberances.

12. The self-leveling modular kitchen system of claim 8 wherein said at least one self-leveling component includes a spring loaded component.

13. The self-leveling modular kitchen system of claim 8 which further includes at least one pivotally mounted grilling component having at least one grilling surface capable of being stored within a cabinet structure, said at least one pivotally mounted grilling component capable of being pivoted and extended to provide sufficient clearance from the walls of said cabinet structure to permit cooking using said at least one electric grilling surface.

14. The self-leveling modular kitchen system of claim 13 wherein said cabinet structure further includes spring loaded pivot arms.

15. The self-leveling modular kitchen system of claim 8 which further includes at least one running face positioned at an angle of 45 to 90 degrees.

16. A self-leveling modular kitchen apparatus comprised of:
at least one pivotally mounted electric grill having at least one grilling surface;
a cabinet structure; and
a pivotally mounted shelf capable of being pivoted and extended to provide sufficient clearance from the interior of said cabinet structure to permit cooking using said at least one grilling surface.
